(19) United States
(12) Patent Application Publication
(10) Pub. No.: US 2009/0261536 A1
(43) Pub. Date: Oct. 22, 2009

(54) QUICK-CONNECT ADAPTER

(75) Inventors: Jeff Beale, Bartlett, TN (US); James Cline, Knoxville, TN (US); Harold Taylor, Memphis, TN (US)

Correspondence Address: MEDTRONIC;Attn: Noreen Johnson - IP Legal Department, 2600 Sofamor Danek Drive, MEMPHIS, TN, 38132, US

(73) Assignee: WARSAW ORTHOPEDIC, INC., Warsaw, IN (US)

(21) Appl. No.: 12/104,569

(22) Filed: Apr. 17, 2008

(51) Int. Cl. B25G 3/22

(52) U.S. Cl. 279/19.7

(57) ABSTRACT

A quick-connect adapter, configured to receive an end of a medical tool, is disclosed and can include a base. A support sleeve can extend from the base having an internal cavity with a first portion defined by a first internal circumferential surface parallel to a major axis of the quick-connect adapter and a second portion defined by a second internal circumferential surface non-parallel to the major axis and generally adjacent to the first portion. A medical tool engagement sleeve can be slidingly disposed within the support sleeve and have a receiving channel and an opening through the engagement sleeve into the receiving channel. The quick-connect adapter can be movable between an engaged configuration, in which the lateral opening is substantially aligned with the second portion of the support sleeve, and an unlocked configuration, in which the lateral opening is substantially aligned with the first portion of the support sleeve.

### BACKGROUND

1. Field of the Disclosure

The present disclosure relates generally to surgical tools. More specifically, the present disclosure relates to adapters for use with surgical tools.

2. Description of Related Art

Surgical tools are used in many medical surgeries. For example, when installing a spinal fixation system along a patient's spine, a surgeon may use a surgical tool to drill one or more holes into bone. The surgeon may also use the surgical tool to install bone screws into each hole. Moreover, the surgeon may use the surgical tool to tighten one or more longitudinal elements installed along the bone screws.

During such a surgery, the surgeon may disengage and re-engage several medical tools with a surgical tool. Adapters have been provided that allow the surgeon to relatively quickly interchange medical tools with the surgical tool. However, to use these adapters, the surgeon may have to manipulate the medical tool and the adapter at substantially the same time. For example, the surgeon may have to hold the medical tool in position within the adapter while tightening the adapter in order to engage and support the medical tool. During a complicated surgery, the surgeon may change medical tools many times. Any additional steps to disengage and re-engage medical tools with the adapter can extend the length of surgery and can increase a risk of complication associated with the surgery.

Accordingly, there is a need for an improved adapter that can be used with a surgical tool.

### BRIEF DESCRIPTION OF THE DRAWINGS

FIG. 1 is a perspective view of a quick-connect adapter;

FIG. 2 is an exploded plan view of the quick-connect adapter;

FIG. 3 is a cross section view of a base associated with the quick-connect adapter;

FIG. 4 is a view of an inner biasing element associated with the quick-connect adapter;

FIG. 5 is a cross section view of a medical tool engagement sleeve associated with the quick-connect adapter;

FIG. 6 is a cross section view of a support sleeve associated with the quick-connect adapter;

FIG. 7 is a view of an outer biasing element associated with the quick-connect adapter.

FIG. 8 is a cross section view of a locking collar associated with the quick-connect adapter;

FIG. 9 is a cross section view of a grip associated with the quick-connect adapter;

FIG. 10 is a cross section view of the quick-connect adapter taken along line 10-10 in FIG. 1;

FIG. 11 is a cross section view of a medical tool for use with the quick-connect adapter;

FIG. 12 is a cross section view of the quick-connect adapter and the medical tool in a pre-engaged configuration;

FIG. 13 is a cross section view of the quick-connect adapter and the medical tool in an engaged configuration;

FIG. 14 is a cross section view of the quick-connect adapter and the medical tool in a locked configuration;

FIG. 15 is a cross section view of the quick-connect adapter and the medical tool in an unlocked configuration;

FIG. 16 is plan view of an alternative embodiment of a base associated with the quick-connect adapter;

FIG. 17 is a perspective view of the tool and the alternative embodiment of the base; and

FIG. 18 is a flow chart illustrating a method of using the quick-connect adapter.

### DETAILED DESCRIPTION

A quick-connect adapter, configured to receive an end of a medical tool, is disclosed and can include a base. A support sleeve can extend from the base. The support sleeve can have an internal cavity having an internal circumferential surface non-parallel to a major axis of the quick-connect adapter. A medical tool engagement sleeve can be slidingly disposed within the support sleeve. The medical tool engagement sleeve can have a medical tool receiving channel and an lateral opening entirely through the medical tool engagement sleeve into the medical tool receiving channel. The quick-connect adapter can have an engagement element located within the lateral opening of the medical tool engagement sleeve. The quick-connect adapter can be movable between an engaged configuration, in which the engagement element is substantially wedged between the medical tool and the internal circumferential surface, and an unlocked configuration, in which the engagement element is not wedged between the medical tool and the internal circumferential surface.

In another embodiment, a method is disclosed and can include inserting a medical tool into a quick-connect adapter. The quick-connect adapter can move to an engaged configuration in which the quick-connect adapter prevents the removal of a medical tool from the quick-connect adapter. The engaged configuration can allow the medical tool to move in an insertion direction. Further, the engaged configuration can allow the medical tool to rotate relative to the quick-connect adapter.

In yet another embodiment, a quick-connect adapter configured to receive an end of a medical tool is disclosed and can include a base. A support sleeve can extend from the base. A medical tool engagement sleeve can be slidingly disposed within the support sleeve. The quick-connect adapter can move between an engaged configuration and a locked configuration. In the engaged configuration, the quick-connect adapter can substantially prevent the removal of the medical tool from the quick-connect adapter. Further, in the engaged configuration, the quick-connect adapter can allow the medical tool to move in an insertion direction and can allow the medical tool to rotate with respect to the quick-connect adapter. In the locked configuration, the quick-connect adapter can substantially prevent the removal of the medical tool from the quick-connect adapter and substantially prevent the rotation of the medical tool with respect to the adapter.

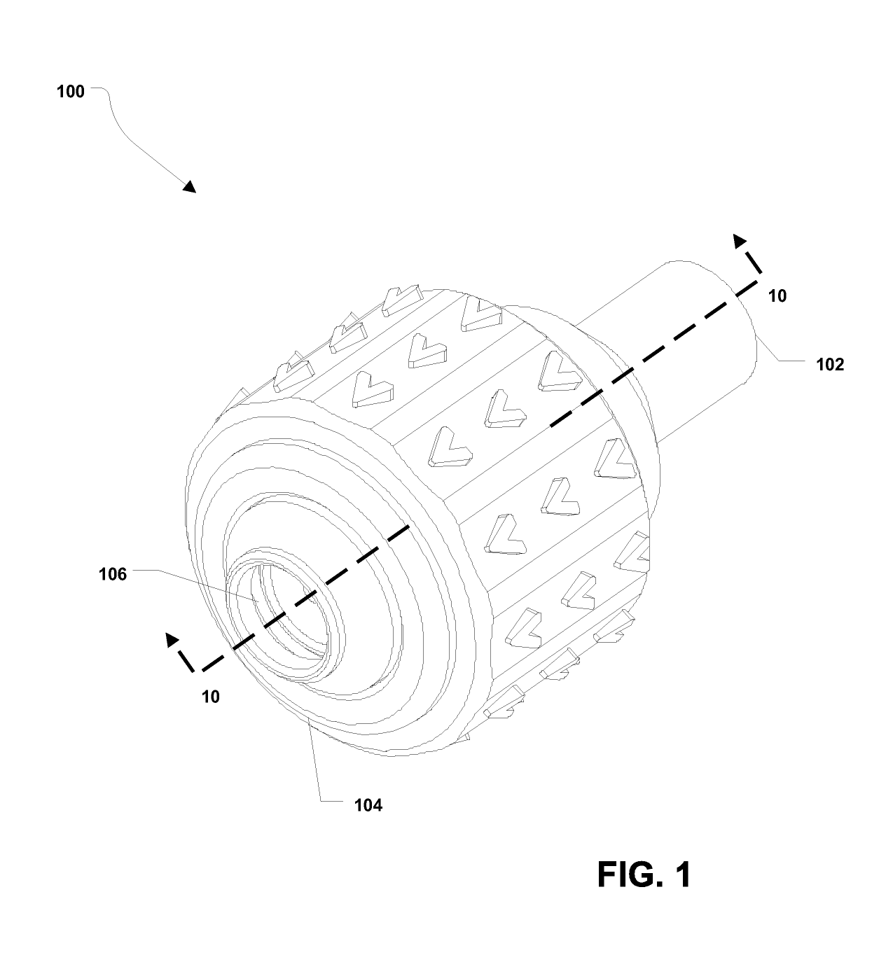

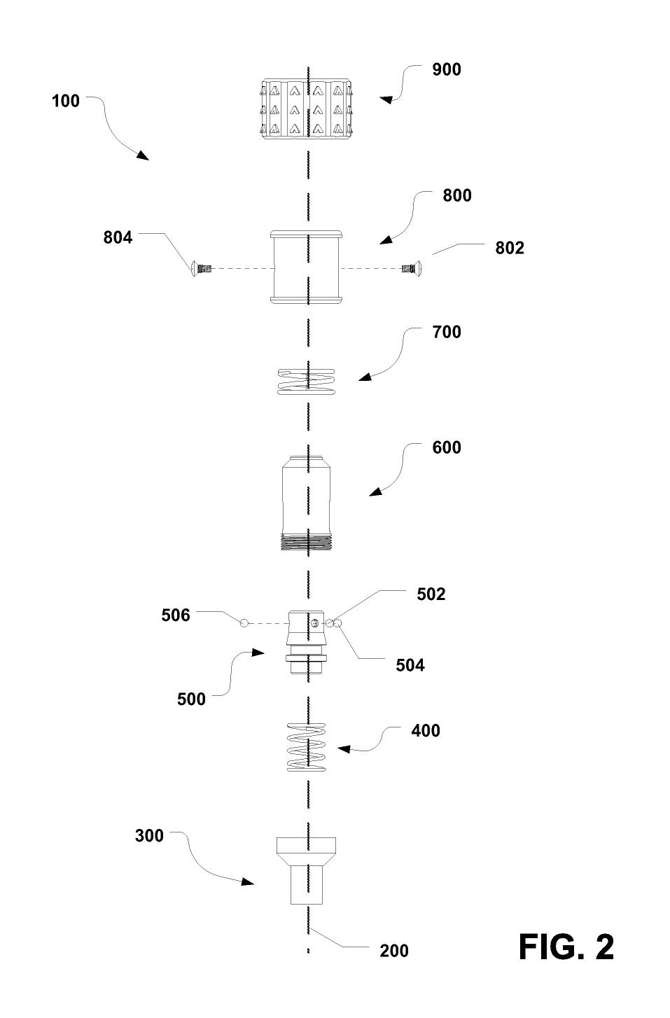

Referring to FIG. 1 and FIG. 2, an embodiment of a quick-connect adapter is shown and is generally designated 100. As shown in FIG. 1, the quick-connect adapter 100 can have a proximal end 102 and a distal end 104. In one embodiment, the proximal end 102 can be mated to a drive spindle of a power surgical tool, e.g., a surgical drill. In such a case, the proximal end 102 of the quick-connect adapter 100 can be captured within a chuck of the surgical drill.

In another embodiment, the proximal end 102 is mated to an unpowered surgical tool, e.g., a handle with a shaft, and can be manually operated. In yet another embodiment, the proximal end 102 of the quick-connect adapter 100 can be integrally formed with a drive spindle of a powered surgical tool. In still another embodiment, the proximal end 102 of the quick-connect adapter 100 can be formed on a shaft of an unpowered surgical tool. A medical tool (not shown in FIG. 1) can be inserted into the medical tool opening 106. As illustrated in FIG. 1, the distal end 104 of the quick-connect adapter 100 can include a medical tool opening 106. In one embodiment, the medical tool can be a drill bit for drilling into bone. In another embodiment, the medical tool can be a screwdriver bit for inserting a screw into a bone. The screwdriver bit can be, but is not limited to, a Phillips bit, a straight bit, a star bit, or a Robertson bit. In another embodiment, the medical tool can be a nut driver bit configured to fit around a hexagonal shaped bolt head or nut. In still another embodiment, the medical tool can be an Allen wrench bit configured to fit into a hexagonal shaped hole, or depression, formed in a bolt head or nut.

In a particular embodiment, the quick-connect adapter 100 can provide a engaged configuration in which the medical tool, once inserted a sufficient distance into the medical tool opening 106, can be substantially prevented from being removed from the quick-connect adapter 100. The engaged configuration can substantially prevent the medical tool from falling out of the quick-connect adapter 100 and substantially prevent the unintentional removal of the medical tool from the quick-connect adapter 100.

Upon further insertion of the medical tool into the quick-connect adapter 100, the quick-connect adapter 100 can move to a locked configuration and the quick-connect adapter 100 can substantially prevent the medical tool from rotating with respect to the quick-connect adapter 100. In this configuration, a surgeon can use the quick-connect adapter 100 to rotate the medical tool. In one embodiment, a surgeon inserts a drill bit into the quick-connect adapter 100 and uses the drill bit to drill a hole in a bone. In another embodiment, a surgeon inserts a screwdriver bit into the quick-connect adapter 100 and uses the screwdriver bit to insert a screw into a bone. Once finished with a medical tool, the quick-connect adapter 100 can be moved to a disengaged, or unlocked, configuration and the medical tool can be removed.

In a particular embodiment, the quick-connect adapter 100 can be sterilized prior to use. As such, the quick-connect adapter 100 can be made of materials that are able to withstand high temperature, high pressure, chemical agents, or a combination thereof in an environment such as an autoclave, a chemiclave, or a sterilization oven. The quick-connect adapter materials can include metals, polymers, ceramics, or a combination thereof. Metals amenable to sterilization can include titanium, stainless steel, or a combination thereof. Polymer materials for sterilization can include acetal copolymer, high-density polyethylene, nylon, polycarbonate, polyethermide, polyphenyl-sulfone, polypropylene, or a combination thereof. Ceramic materials for sterilization can include alumina oxide, silica oxide, zirconium oxide, aluminum oxide, or a combination thereof.

As shown in FIG. 2, the quick-connect adapter 100 can have a major axis 200. The following components of the quick-connect adapter 100 can be generally aligned along the major axis 200. The quick-connect adapter 100 can include a base 300. An inner biasing element 400 can be install within the base 300. A medical tool engagement sleeve 500 can also be installed partially within the inner biasing element 400. The inner biasing element 400 can be compressed between the base 300 and the medical tool engagement sleeve 500.

As depicted in FIG. 2, one or more engagement elements 502, 504, 506 can extend from, or be install within, the engagement sleeve 500. For example, the engagement elements 502, 504, 506 can be balls, pins, cylindrical rollers, or wedges. A support sleeve 600 can be installed around the inner biasing element 400 and the medical tool engagement sleeve 500. As described in detail below, the support sleeve 600 can be threadingly engaged within the base 300. Further, an outer biasing element 700 can be installed around the support sleeve 600. The inner biasing element 400 and outer biasing element 700 can be springs. An unlocking collar 800 can also be installed around the support sleeve 600 and the unlocking collar 800 can compress the outer biasing element 700 against the base 300. As depicted in FIG. 2, one or more coupling elements 802, 804 can extend from, or be installed within, the unlocking collar 800. In a particular embodiment, the coupling elements 802, 804 can be screws, press fitted pins, or rolled pins. Additionally, the quick-connect adapter 100 can have a grip 900 installed around the unlocking collar 800. Alternatively, the grip 900 can be integrally formed on the unlocking collar 800.

### Description of the Base of the Quick Connect Adapter

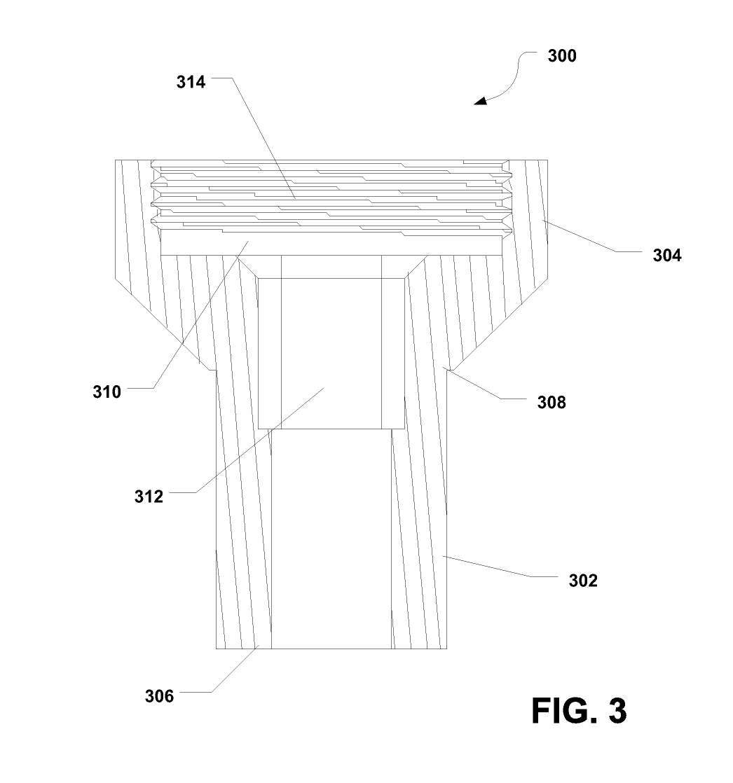

Referring to FIG. 3, details concerning the base 300 can be seen. As shown, the base 300 can include a shaft 302 and a head 304. In particular, the shaft 302 can have a proximal end 306 and a distal end 308. The head 304 can be coupled to, or integrally formed with, the distal end 308 of the shaft 302.

In one embodiment, the proximal end 302 can be mated to a drive spindle of a powered surgical tool, e.g., a surgical drill. In such a case, the proximal end 302 of the quick-connect adapter 100 can be captured within a Jacobs chuck of the surgical drill.

In another embodiment, the proximal end 302 is mated to an unpowered surgical tool, e.g., a handle with a shaft, and can be manually operated. In yet another embodiment, the proximal end 302 of the base 300 can be integrally formed with a drive spindle of a powered surgical tool. In still another embodiment, the proximal end 302 of the base 300 can be formed on a shaft of an unpowered surgical tool.

FIG. 3 further indicates that the base 300 can be formed with an internal cavity 310. The internal cavity 310 can have a medical tool locking depression 312 that can extend at least partially into the distal end 308 of the shaft 302. Further, the internal cavity 310 can include a threaded portion 314 adjacent to the medical tool locking depression 312. As described in detail below, the threaded portion 314 can be engaged with the support shaft 600 when the quick-connect adapter 100 is assembled.

### Description of the Inner Biasing Element of the Quick-Connect Adapter

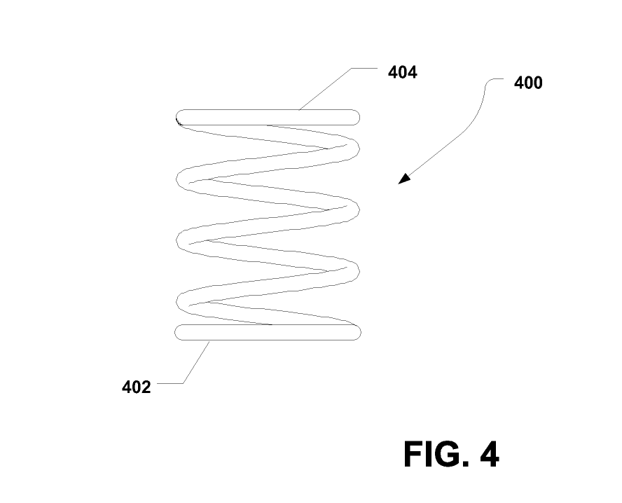

FIG. 4 shows the inner biasing element 400. In an exemplary embodiment, the inner biasing element 400 is a spring. The inner biasing element 400 can have a proximal end 402 and a distal end 404. As described in detail below, the inner biasing element 400 can be installed in compression between the medical tool engagement sleeve 500 (FIG. 2) and the base 300 (FIG. 2). Particularly, the proximal end 402 can be installed within the internal cavity 310 (FIG. 3) formed in the base 300 (FIG. 3). A portion of the medical tool engagement sleeve 500 (FIG. 2) can extend into the distal end 404 of the inner biasing element 400.

### Description of the Medical Tool Engagement Sleeve of the Quick-Connect Adapter

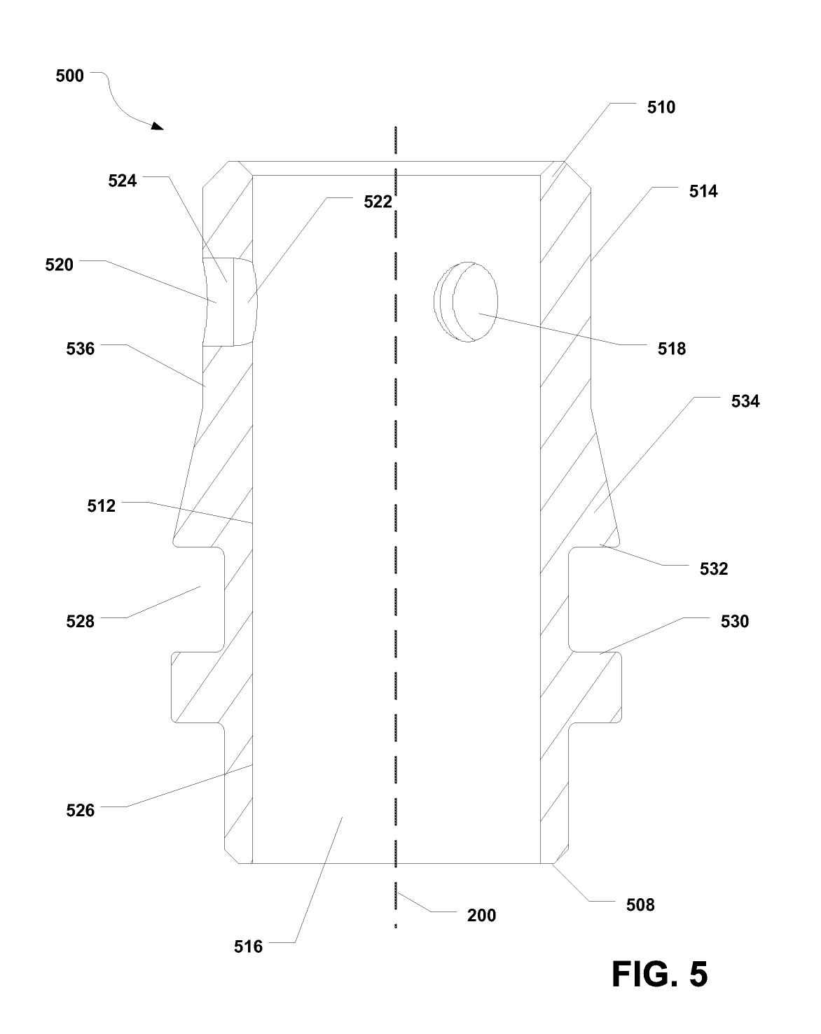

FIG. 5 shows an embodiment of the medical tool engagement sleeve 500. The medical tool engagement sleeve 500 can have a proximal end 508 and a distal end 510. Further, the medical tool engagement sleeve 500 can have an inner surface 512 and an outer surface 514. The inner surface 512 can define a medical tool receiving channel 516. The medical tool receiving channel 516 can be generally cylindrical.

In an exemplary embodiment, one or more lateral openings 518, 520 can extend through the medical tool engagement sleeve 500 into the medical tool receiving channel 516. The lateral openings 518, 520 can be radially spaced around the medical tool engagement sleeve 500. An inner part 522 of each lateral opening 518, 520 can have a smaller diameter than an outer part 524 of each lateral opening 518, 520. Further, the inner part 522 of each lateral opening 518, 520 can be smaller than a respective engagement element 502, 504, 506 (FIG. 2) that can be disposed therein. As described in detail below, the engagement elements 502, 504, 506 (FIG. 2) can be retained within the lateral openings 518, 520 by the inner part 522 and the support sleeve 600 (FIG. 2).

As illustrated in FIG. 5, the outer surface 514 of the medical tool engagement sleeve 500 can have an outer biasing element engagement surface 526 near the proximal end 508 of the medical tool engagement sleeve 500. The outer biasing element 700 (FIG. 2) can engage the outer biasing element engagement surface 526 to bias the medical tool engagement sleeve 500 in a distal direction. The outer surface 514 can have a channel 528 and the channel 528 can include a proximal rod engagement surface 530 and a distal rod engagement surface 532. The outer surface 514 can have a sloped portion 534 adjacent to the channel 528. Further, the sloped portion 534 tapers to a parallel portion 536. As such, the medical tool engagement sleeve 500 is sized and shaped to fit into the support sleeve 600 (FIG. 2).

In an exemplary embodiment the sloped portion 534 has an angle in a range of ten to fifteen degrees (10°-15°). Further, the angle of the sloped portion 534 can be in a range of twelve to fourteen degrees (12-14°). Moreover, the lateral opening 518, 520 can be generally located within the parallel region 536.

### Description of the Support Sleeve of the Quick-Connect Adapter

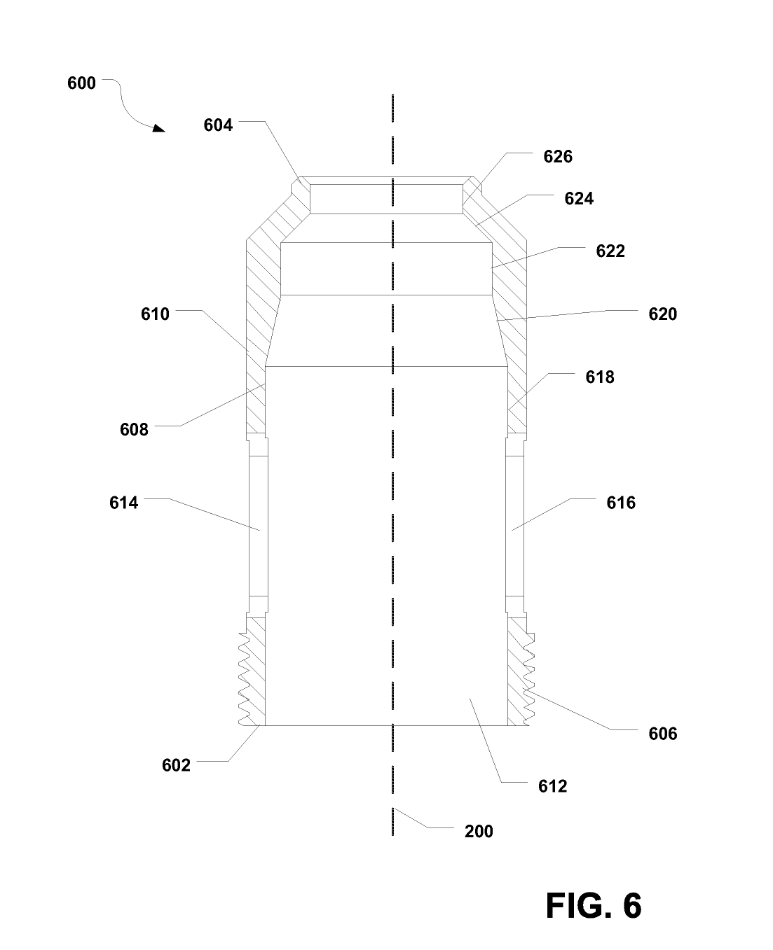

Referring to FIG. 6, a cross section of the support sleeve 600 of the quick-connect adapter 100 (FIG. 1) is shown. The support sleeve 600 can have a proximal end 602 and a distal end 604. The proximal end 602 of the support sleeve 600 can have a threaded region 606 that is sized and shaped to fit into and threadably engage the threaded region 314 (FIG. 3) of the base 300 (FIG. 3). The support sleeve 600 can have an inner surface 608 and an outer surface 610. The inner surface 608 defines an internal cavity 612. In an exemplary embodiment, lateral openings 614, 616 extend through the support sleeve 600 into the internal cavity 612. The lateral openings 614, 616 can be radially spaced around support sleeve 600.

As indicated in FIG. 6, the inner surface 608 can have a first internal circumferential surface 618 parallel to the major axis 200. Adjacent to the first internal circumferential surface 618 can be a second internal circumferential surface 620 non-parallel to the major axis 200. In an embodiment, a line extended from the second internal circumferential surface 620 would intersect the major axis 200 at an angle within a range of five to fifteen degrees (5°-15°). Further, the angle of the second internal circumferential surface 620 to the major axis 200 can be in a range of eight to twelve degrees (8-12°). A third internal circumferential surface 622 can be adjacent to the second internal circumferential surface 620. The third internal circumferential surface 622 can be parallel to the major axis 200. Further, a forth internal circumferential surface 624, non-parallel to the major axis 200, can be adjacent to the third internal circumferential surface 622, and a fifth internal circumferential surface 626 can be adjacent to the forth internal circumferential surface 624. The fifth internal circumferential surface 626 can be generally parallel to the major axis 200.

### Description of the Outer Biasing Element of the Quick-Connect Adapter

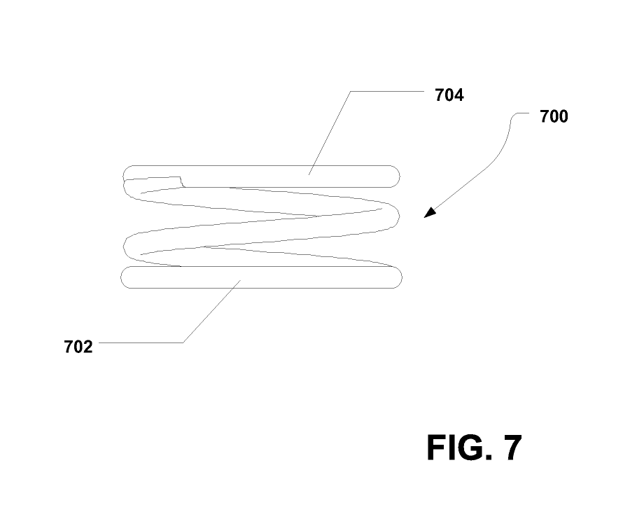

FIG. 7 shows a plan view of the outer biasing element 700. In an exemplary embodiment, the outer biasing element 700 is a spring. The outer biasing element 700 can have a proximal end 702 and a distal end 704. As described in detail below, the outer biasing element 700 can be installed in compression between the unlocking collar 800 (FIG. 2) and the base 300 (FIG. 2). A portion of the unlocking collar 800 (FIG. 2) can extend into the distal end 704 of the outer biasing element 700.

### Description of the Unlocking Collar of the Quick-Connect Adapter

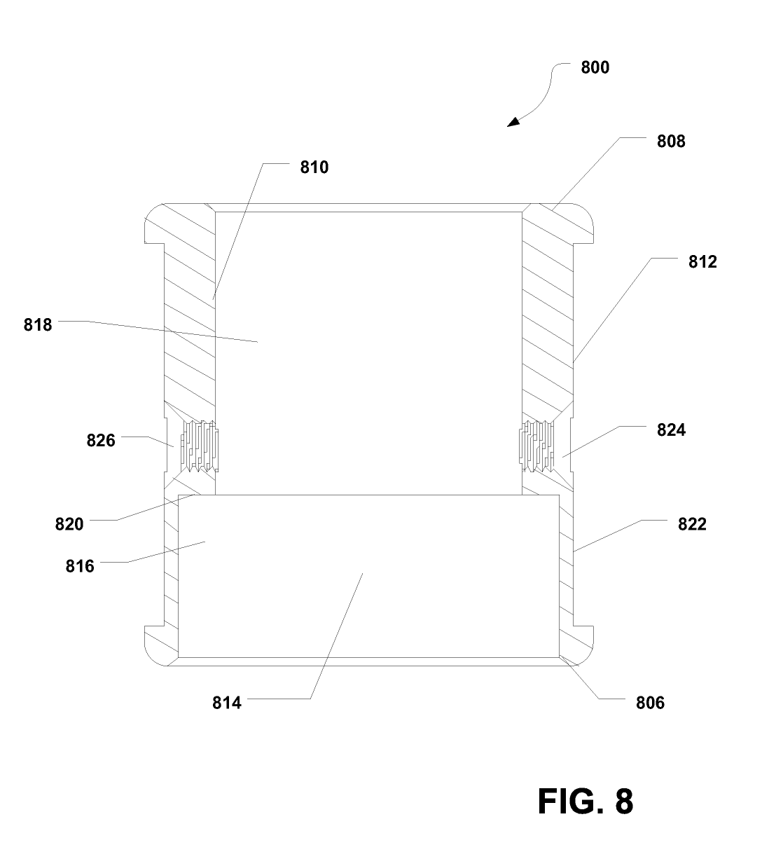

Referring to FIG. 8, a cross section of the unlocking collar 800 of the quick-connect adapter 100 (FIG. 1) is shown. The unlocking collar 800 can have a proximal end 806 and a distal end 808. Further, the unlocking collar 800 can have an inner surface 810 and an outer surface 812. As indicated in FIG. 8, the inner surface 810 can define a support sleeve channel 814. The support sleeve channel 814 can have a first region 816 and a second region 818. In a particular embodiment, the first region 816 can have a diameter that is relatively larger than a diameter of the second region 818. Also, the first region 816 can be configured to receive the outer biasing element 700 (FIG. 7). In an exemplary embodiment, the interface between the first region 816 and the second region 818 defines an outer biasing element engagement surface 820 upon which the outer biasing element 700 (FIG. 7) can act.

As shown in FIG. 8, the outer surface can be constructed with a wide shallow channel 822. In an exemplary embodiment, the wide shallow channel 822 is configured to receive the grip 900 (FIG. 2). Specifically, the grip 900 (FIG. 2) can fit around the unlocking collar 800, e.g., within the wide shallow channel 822. The unlocking collar 800 can also be constructed with one or more coupling element openings 824, 826 extending through the unlocking collar 800 into the support sleeve channel 814. As described in detail below, the coupling elements 802, 804 (FIG. 2) can extend from the coupling element openings 824, 826, through the lateral openings 614, 616 (FIG. 6) of the support sleeve (FIG. 6) and into the channel 528 (FIG. 5) of the medical tool engagement sleeve (FIG. 5). In an exemplary embodiment, the coupling element openings 824, 826 are threaded to correspond to the threading on the coupling elements 802, 804 (FIG. 2).

### Description of the Grip of the Quick-Connect Adapter

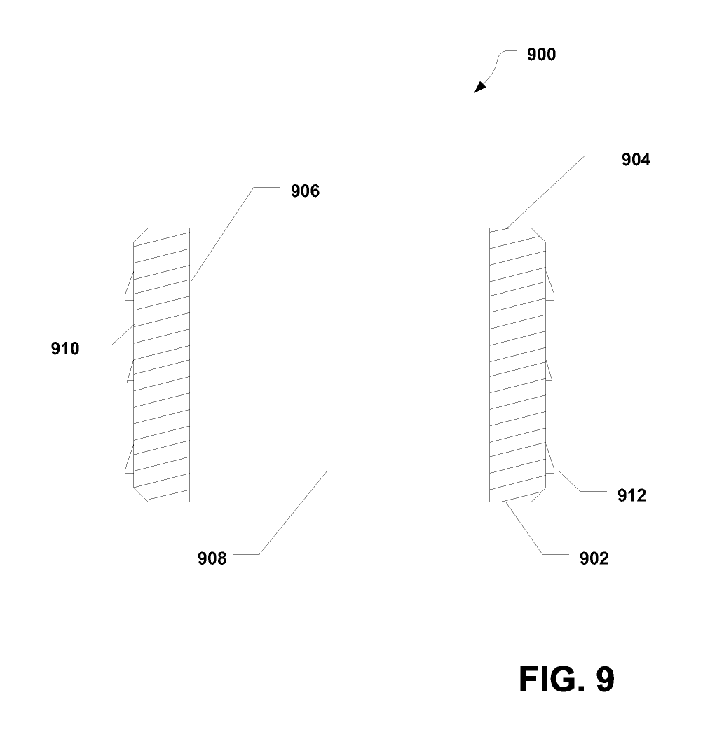

FIG. 9 shows a cross section of the grip 900 of the quick-connect adapter 100 (FIG. 1). The grip 900 can have a proximal end 902 and a distal end 904. The grip 900 can have an inner surface 906 defining an unlocking collar channel 908. The unlocking collar channel 908 can be configured to fit around and engage the unlocking collar 800 (FIG. 8). In an exemplary embodiment, the unlocking collar channel 908 is generally cylindrical. The grip 900 can have an outer surface 910. In an exemplary embodiment, one or more protrusions 912 can extend from the outer surface 910. As such, the outer surface 910 can be textured.

### Quick-Connect Adapter Assembled

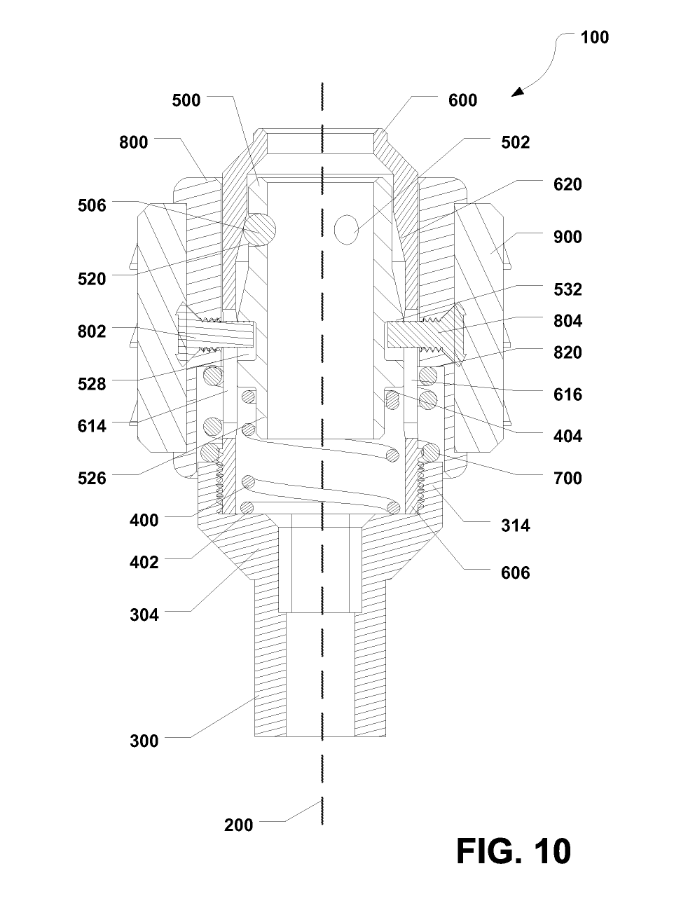

FIG. 10 shows a cross section of the quick-connect adapter 100, taken along the line 10-10 in FIG. 1. In general, the components 300, 400, 500, 600, 700, 800, 900 of the quick-connect adapter 100 can be aligned along the major axis 200. Further, the components 300, 400, 500, 600, 700, 800, 900 can be concentric to each other around the major axis 200.

As illustrated in FIG. 10, the proximal end 402 of the inner biasing element 400 can be placed within the head 304 of the base 300. Further, the proximal end 508 of the medical tool engagement sleeve 500 can fit into the distal end 404 of the inner biasing element 400. The support sleeve 600 can fit around the inner biasing element 400 and the medical tool engagement sleeve 500. Further, the medical tool engagement sleeve 500 and the support sleeve 600 can be threadingly engaged with the base 300. Specifically, the threaded region 606 of the support sleeve 600 can be threaded into the threaded portion 314 of the base 300. The engagement elements 502, 506 can extend from, or be installed within, the lateral openings 520 of the medical tool engagement sleeve 500.

In an exemplary embodiment, the inner biasing element 400 is configured to bias the medical tool engagement sleeve 500 to an engaged position. In the engaged position, the lateral openings 520 can be substantially aligned with the second portion 620 of the support sleeve 600. When the lateral openings 520 are aligned with the second internal circumferential surface 620, the second internal circumferential surface 620 can bias the engagement elements 502, 506 in an inward direction, as shown.

The unlocking collar 800 can be installed around the support sleeve 600 and the outer biasing element 700 can be installed around the support sleeve 600. Moreover, the outer biasing element 700 can be compressed between the head 304 of the base 300 and the outer biasing element engagement surface 820 of the unlocking collar 800. The coupling elements 802, 804 can extend from the unlocking collar 800, through the lateral openings 614, 616 of the support sleeve 600 and into the channel 528 of the medical tool engagement sleeve 500. In an exemplary embodiment, the outer biasing element 700 is configured to bias the unlocking collar 800 to a locked position. In the locked position, the coupling elements 802, 804 can be in contact with the distal surface 532 of the tool engagement sleeve 500. The grip 900 can be installed around and engage the unlocking collar 800.

Description of the Medical Tool Associated with the Quick-Connect Adapter

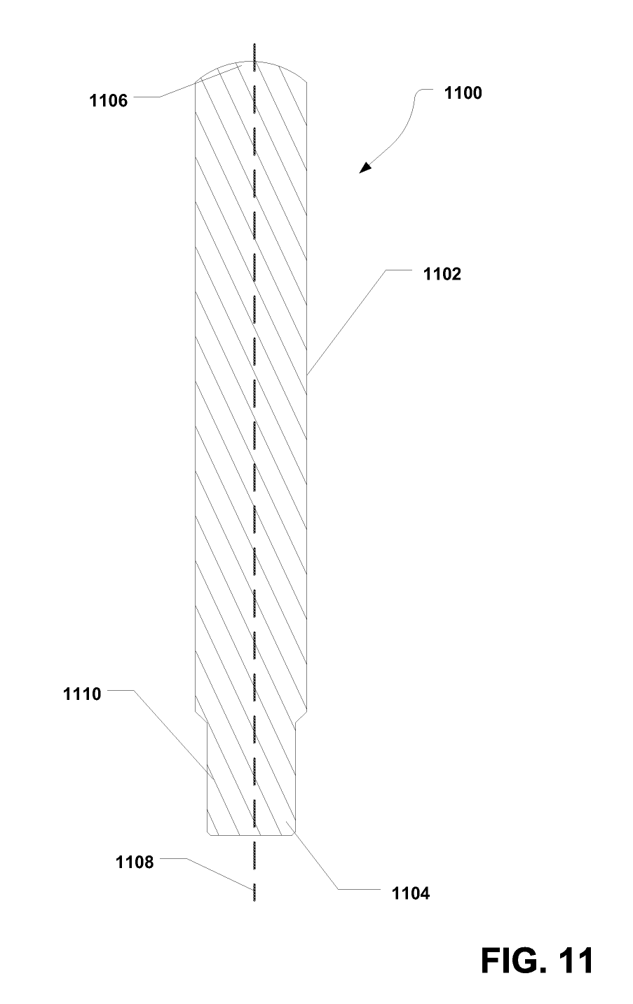

FIG. 11 shows a cross section of an embodiment of a medical tool 1100 for use with the quick-connect adapter 100. In one embodiment, the medical tool 1100 can be a drill bit for drilling into bone. In another embodiment, the medical tool 1100 can be a screwdriver bit for inserting a screw into a bone. The screwdriver bit can be, but is not limited to, a Phillips bit, a straight bit, a star bit, or a Robertson bit. In another embodiment, the medical tool 1100 can be a nut driver bit configured to fit around a hexagonal shaped bolt head or nut. In still another embodiment, the medical tool 1100 can be an Allen wrench bit configured to fit into a hexagonal shaped hole, or depression, formed in a bolt head or nut.

As shown in FIG. 11, the medical tool 1100 can have a shaft 1102. The shaft 1102 can be elongated and generally cylindrical. Further, the shaft 1102 of the medical tool 1100 can have a proximal end 1104 and a distal end 1106. Additionally, the medical tool 1100 can have a major axis 1108. In an exemplary embodiment, the shaft 1102 can include an end section 1110. The end section 1110, when cross-sectioned in the plane orthogonal to the major axis 1108, can have a multi-faced cross-section. The multi-faced cross section can be, but is not limited to, a triangle, a square, a star, a hexagon, or some other polygonal surface. In an embodiment, the end section 1110 is configured to correspond with the medical tool locking depression 312 (FIG. 3) of the quick-connect adapter 100. In an embodiment, the shaft 1102 of the medical tool 1100 can be sized and shaped to fit into the medical tool receiving channel 516 (FIG. 5) of the medical tool engagement sleeve 500 (FIG. 5).

### Description of the Quick-Connect Adapter in a Pre-Engaged Configuration

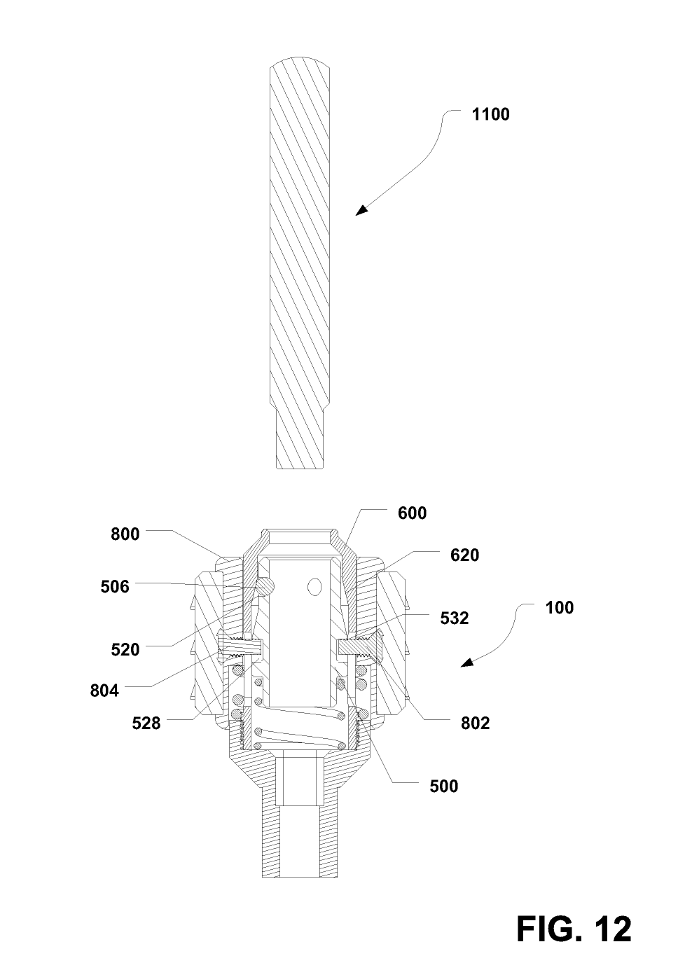

FIG. 12 shows a cross section of the medical tool 1100 and the quick-connect adapter 100 prior to the medical tool 1100 being inserted into the quick-connect adapter 100. As shown, the quick-connect adapter 100 can be in a pre-engaged configuration. In a particular embodiment, the inner biasing element 400 can bias the medical tool engagement sleeve 500 towards the distal end 104 of the quick-connect adapter 100 so that the lateral openings 520 formed in the tool engagement sleeve 500 are aligned with the second internal circumferential surface 620 of the support sleeve 600. In the pre-engaged configuration, the second internal circumferential surface 620 of the support sleeve can bias the engagement elements 502, 506 in an inward direction relative to the medical tool engagement sleeve 500. In an exemplary embodiment, in the pre-engaged configuration, the outer biasing element 700 can bias the unlocking collar 800 toward a locked position. Further, in the locked position, the coupling elements 802, 804 can be in contact with the distal surface 532 of the channel 528 of the tool engagement sleeve 500.

### Description of the Quick-Connect Adapter in an Engaged Configuration

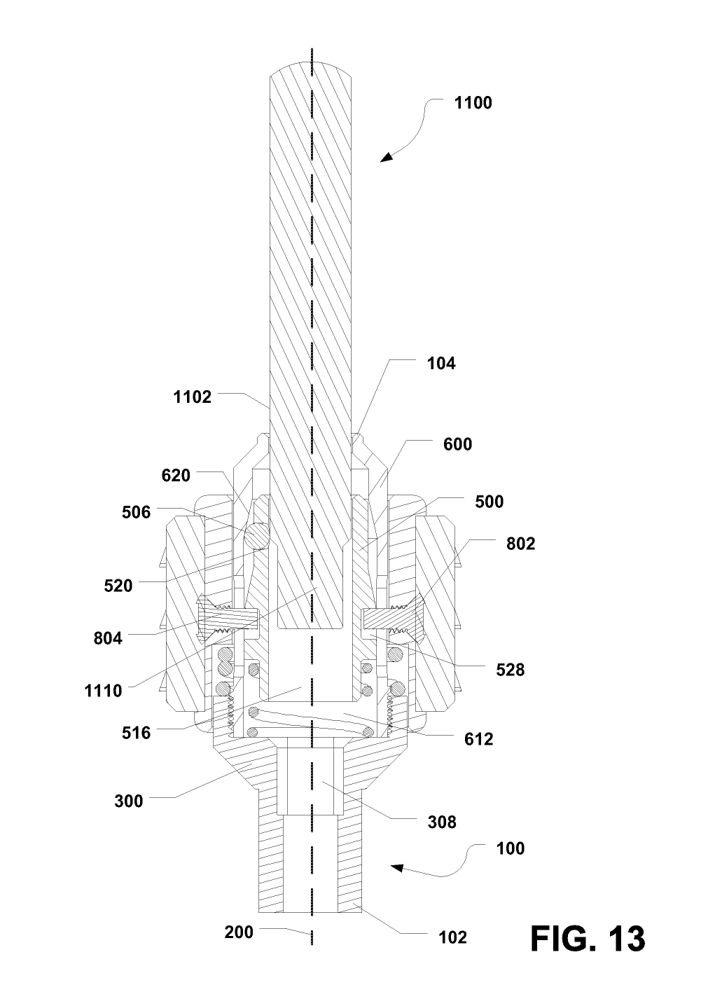

FIG. 13 shows a cross section of the quick-connect adapter 100 and the medical tool 1100 in an engaged configuration. In the engaged configuration, the shaft 1102 of the medical tool 1100 can be at least partially inserted into the medical tool receiving channel 516 of the medical tool engagement sleeve 500. However, the end section 1110 of the medical tool 1100 is not engaged with, or inserted within, the medical tool locking depression 312 of the base 300.

In the engaged configuration, as the medical tool 1100 is installed into the quick-connect adapter 100, the cylindrical shaft 1102 of the medical tool 1100 can bias the engagement element 506 in an outward direction. Further, the medical tool engagement sleeve 500 can move in toward the base 300 and the lateral opening 520 can move toward the second internal circumferential surface 620 of the support sleeve 600. The engagement element 506 can be compressed between the shaft 1102 of the medical tool 1100 and the second internal circumferential surface 620 of the support sleeve 600.

Further, in the engaged configuration, the quick-connect adapter 100 can substantially prevent the removal of the medical tool 1100 from the quick-connect adapter 100. Attempted removal of the medical tool 1100 can create a force to move the engagement element 506 towards the distal end 104 of the quick-connect adapter 100. In an exemplary embodiment, the internal cavity 612 narrows in the distal direction as a result of the angle of the second internal circumferential surface 620 with respect to the major axis 200. The narrowing of the internal cavity 612 can result in an inward force on the engagement element 506, as the medical tool engagement sleeve 500 moves away from the base 300, substantially preventing the removal of the medical tool 1100 from the quick-connect adapter 100.

In a particular embodiment, in the engaged configuration, the quick-connect adapter 100 can allow further insertion of the medical tool 1100 toward the base 300 of the quick-connect adapter 100. Further insertion of the medical tool 1100 can move the engagement element 506 towards the proximal end 102 of the quick-connect adapter 100. In an embodiment, the internal cavity 612 widens in the proximal direction as a result of the angle of the second internal circumferential surface 620 with respect to the major axis 200. The widening of the internal cavity 612 can reduce the inward force on the engagement element 506. In an exemplary embodiment, the force of the inner biasing element 400 on the medical tool engagement sleeve 500 balances the force of the insertion of the medical tool 1100 and the medical tool engagement sleeve 500 maintains an equilibrium position as the engagement element 506 rolls, or moves, along the cylindrical section 1110 of the medical tool 1100 while the medical tool 1100 is inserted further into the quick-connect adapter 100.

In the engaged configuration, the quick-connect adapter 100 can allow the rotation of the medical tool 1100 with respect to the quick-connect adapter 100. Rotation of the medical tool 1100 can cause the engagement element 506 to move in a circumferential direction. The circumferential movement of the engagement element 506 can cause a rotational movement of the medical tool engagement sleeve 500. In an exemplary embodiment, the channel 528 on the medical tool engagement sleeve 500 allows the medical tool engagement sleeve 500 to rotate with respect to the coupling elements 802, 804.

### Description of the Quick-Connect Adapter in a Locked Configuration

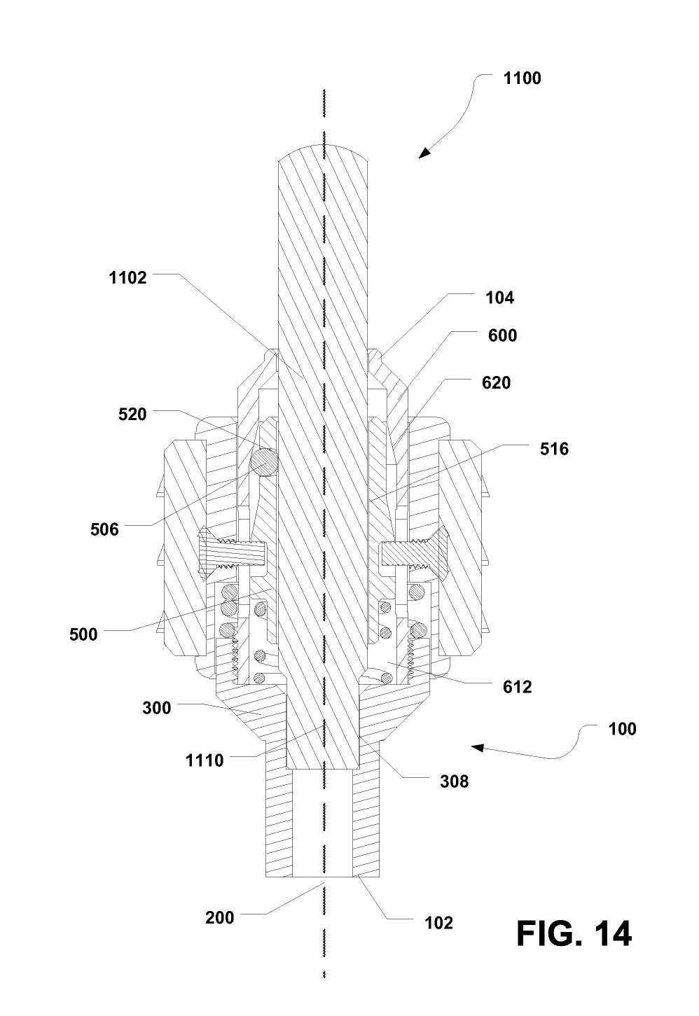

FIG. 14 shows a cross section of an embodiment of the quick-connect adapter 100 and the medical tool 1100 in a locked configuration. In an exemplary embodiment, in the locked configuration, the cylindrical shaft 1102 of the medical tool 1100 can be substantially inserted into the medical tool receiving channel 516 of the medical tool engagement sleeve 500. The end section 1110 of the cylindrical shaft 1102 can engage the medical tool locking depression 312 of the base 300. The lateral opening 516 of the medical tool engagement sleeve 500 can be substantially aligned with the second internal circumferential surface 620 of the support sleeve 600. The engagement element 506 can be compressed between the shaft 1102 of the medical tool 1100 and the second internal circumferential surface 620 of the support sleeve 600.

In the locked configuration, the quick-connect adapter 100 can substantially prevent the removal of the medical tool 1100 from the quick-connect adapter 100. Attempted removal of the medical tool 1100 can create a force to move the engagement element 506 towards the distal end 104 of the quick-connect adapter 100. In an exemplary embodiment, the internal cavity 612 narrows in the distal direction as a result of the angle of the second portion 620 with respect to the major axis. The narrowing of the internal cavity 612 can result in an inward force on the engagement element 506, substantially preventing the removal of the medical tool 1100 from the quick-connect adapter 100.

In the locked configuration, rotation of the medical tool 1100 with respect to the quick-connect adapter 100 is prevented by the engagement of the end section 1110 of the medical tool 1100 in the medical tool locking depression 312 of the base 300.

In an exemplary embodiment, axial movement of the unlocking collar 800 relative the engagement sleeve 500 acts to substantially prevent unintentional unlocking of the quick-connect adapter 100. The outer biasing element 700 acts to bias the coupling elements 802, 804 towards the distal rod engagement surface 532 of the channel 528. The width of the channel 528 provides a distance over which the unlocking collar 800 must travel before the coupling elements 802, 804 can contact the proximal rod engagement surface 530 and move the engagement sleeve 500 in a proximal direction, resulting in the unlocking of the quick-connect adapter 100.

In an alternate embodiment, axial movement of the unlocking collar 800 relative to the engagement sleeve 500 can be prohibited. For example, the width of the channel 528 can be small such that the coupling elements 802, 804 simultaneously contact both the proximal rod engagement surface 530 and distal rod engagement surface 532. In said embodiment, only one of the inner biasing element 400 and the outer biasing element 700 is necessary and can act to bias both the engagement sleeve 500 and unlocking collar 800 in a distal direction.

### Description of the Quick-Connect Adapter in an Unlocked Configuration

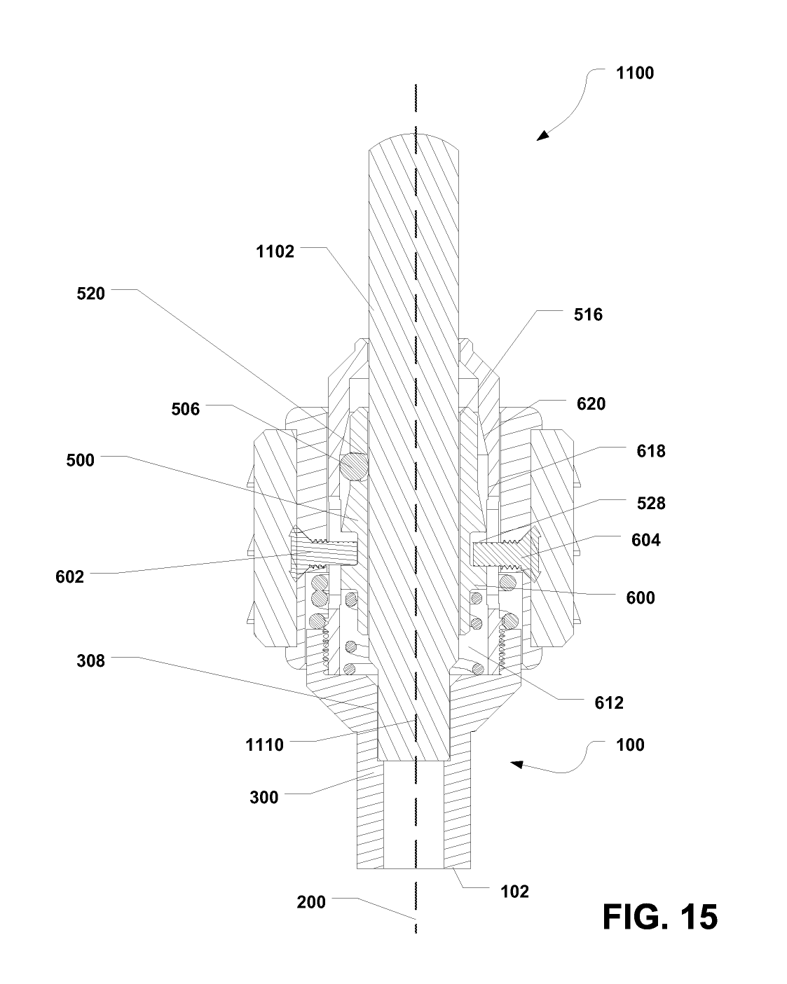

FIG. 15 shows a cross section of an embodiment of the quick-connect adapter 100 and the medical tool 1100 in an unlocked configuration. The shaft 1102 of the medical tool 1100 can be substantially inserted into the medical tool receiving channel 516 of the medical tool engagement sleeve 500. The end section 1110 of the medical tool 1100 can engage the medical tool locking depression 312 of the base 300. The lateral opening 520 of the medical tool engagement sleeve 500 can be substantially aligned with the first internal circumferential surface 618 of the support sleeve 600. The coupling elements 602, 604 can be aligned with the proximal surface 530 of the channel 528 in the medical tool engagement sleeve 500.

In the unlocked configuration, the quick-connect adapter 100 can allow the removal of the medical tool 1100 from the quick-connect adapter 100. In an exemplary embodiment, the alignment of the coupling elements 602, 604 with the proximal surface 530 of the channel 528 in the medical tool engagement sleeve 500 can substantially prevent the medical tool engagement sleeve 500 and the engagement element 506 from moving in a distal direction. The increased diameter of the internal cavity 612 along the first internal circumferential surface 618, relative to the diameter of the internal cavity 612 along the second internal circumferential surface 620, of the support sleeve 600 can reduce the inward force on the engagement element 506 and can allow the removal of the medical tool 1100.

### ALTERNATIVE EMBODIMENT OF THE BASE

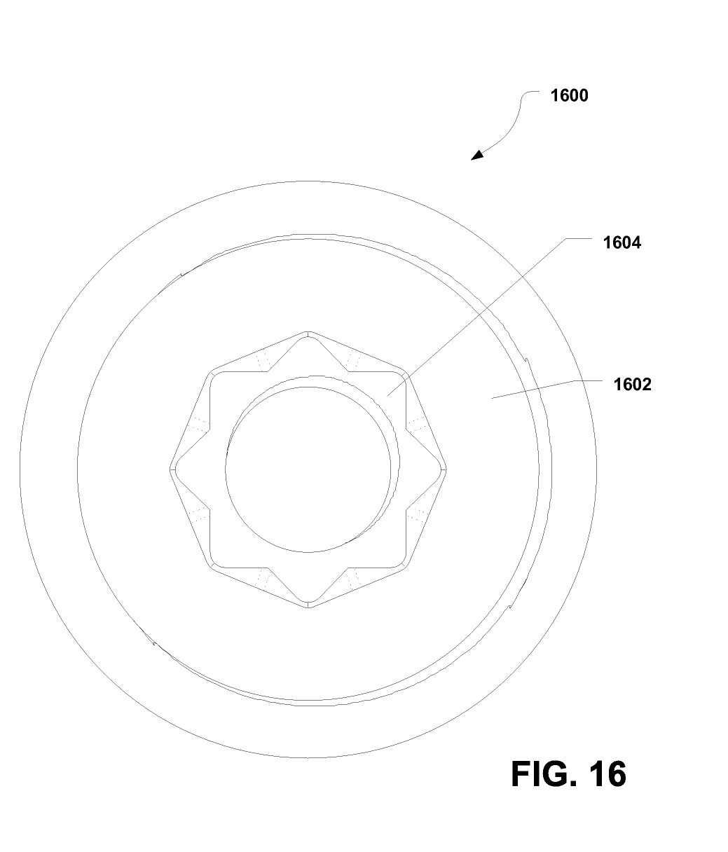

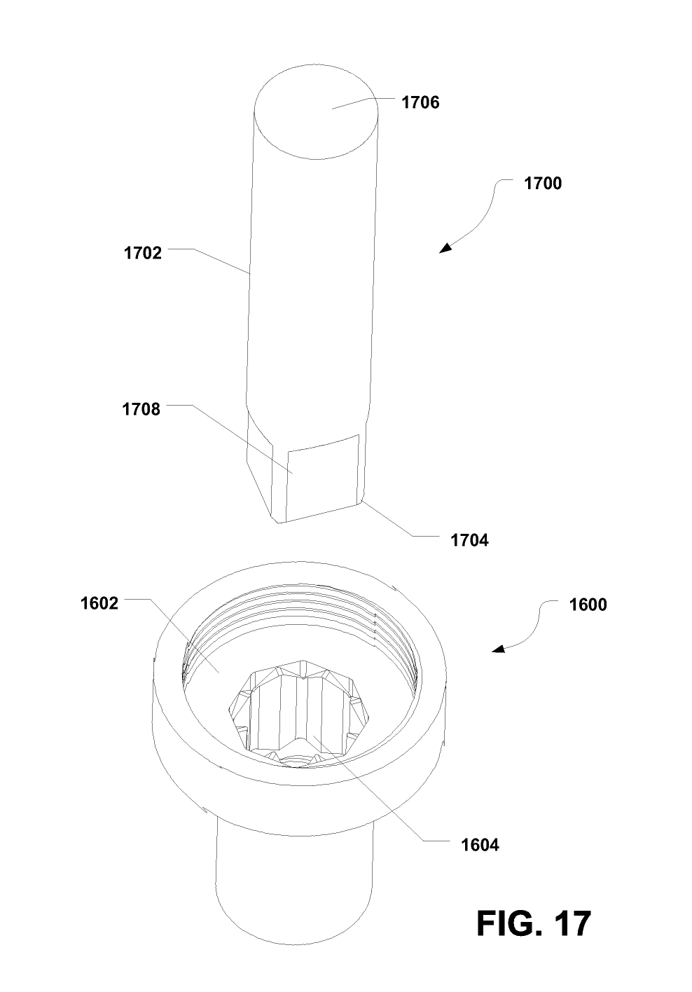

Referring to FIG. 16 and FIG. 17, an alternative embodiment of the base is shown and generally designated 1600. FIG. 16 shows a view of the base 1600 along the major axis (not shown), i.e., a top view of the base 1600. As shown, the base 1600 can be formed with an internal cavity 1602. The internal cavity 1602 can have a medical tool locking depression 1604 configured with an 8-pointed cross-section, represented by two overlapping squares with rounded corners offset by about a forty-five degree (45°) rotation.

FIG. 17 shows an embodiment of a medical tool 1700. The medical tool 1700 has a shaft 1702 with a proximal end 1704 and a distal end 1706. The medical tool 1700 can have an end section 1708 at the proximal end 1704. The end section 1708 can have a square shaped cross-section. The end section 1708 can be inserted into the medical tool locking depression 1604 of the base 1600. The end section 1708 can be aligned with the medical tool locking depression 1604 of the base 1600 with a rotation of at most about forty-five degree (45°) in either direction.

In an exemplary embodiment, the edges of the medical tool locking depression 1604 are beveled. As such, the medical tool locking depression 1604 may be substantially self-aligning, the bevel causing sufficient rotation of the medical tool 1700 to align the end section 1708 with the medical tool locking depression 1604.

### Method of Using a Quick-Connect Adapter

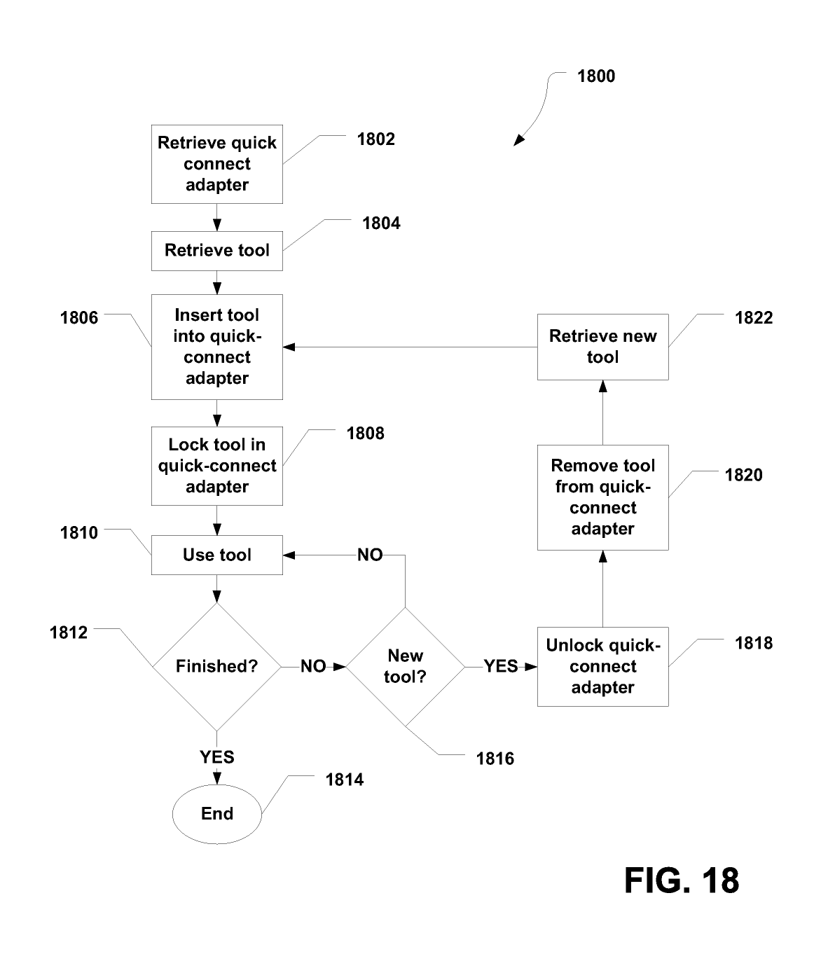

FIG. 18 shows a flow diagram of an exemplary method of using a quick-connect adapter. Commencing at block 1802, a surgeon can retrieve the quick-connect adapter. In one embodiment, the quick-connect adapter can be mated to a drive spindle of a power surgical tool, e.g., a surgical drill. In such a case, the quick-connect adapter can be captured within a Jacobs chuck of the surgical drill. In another embodiment, the quick-connect adapter is mated to an unpowered surgical tool, e.g., a handle with a shaft, and can be manually operated. In yet another embodiment, the quick-connect adapter can be integrally formed with a drive spindle of a powered surgical tool. In still another embodiment, the quick-connect adapter can be formed on a shaft of an unpowered surgical tool.

Shown at 1804, the surgeon can retrieve a medical tool. In one embodiment, the medical tool can be a drill bit for drilling into bone. In another embodiment, the medical tool can be a screwdriver bit for inserting a screw into a bone. The screwdriver bit can be, but is not limited to, a Phillips bit, a straight bit, a star bit, or a Robertson bit. In another embodiment, the medical tool can be a nut driver bit configured to fit around a hexagonal shaped bolt head or nut. In still another embodiment, the medical tool can be an Allen wrench bit configured to fit into a hexagonal shaped hole, or depression, formed in a bolt head or nut.

Referring to FIG. 18, the surgeon can insert the medical tool into the quick-connect adapter, as shown at 1806. Upon insertion of the medical tool into the quick-connect adapter, the quick-connect adapter can substantially prevent the medical tool from being removed from the quick-connect adapter. Illustrated at 1808, the surgeon can lock the rotation of the medical tool relative to the quick-connect adapter. Locking the rotation of the medical tool can occur substantially at the same time as inserting the medical tool into the quick-connect adapter. Locking the rotation of the medical tool can occur by rotating the medical tool to align with a tool locking depression and further inserting the medical tool to engage the tool locking depression.

Referring to FIG. 18, the surgeon can use the medical tool, as shown at 1810. In an exemplary embodiment, the medical tool can be a drill bit and the surgeon can drill a hole in a bone of a patient. In another exemplary embodiment, the medical tool can be a screwdriver bit and the surgeon can secure an implant to a bone of a patient by inserting a screw into the bone. As illustrated at 1812, if the surgeon is finished using the medical tool, the method can end at state 1814. Otherwise, as illustrated at 1816, if the surgeon does not need a new tool, the surgeon can return to 1810 to use the tool.

Proceeding from 1816, if a new tool is needed, the surgeon can release the medical tool from the quick-connect adapter, as shown in 1818. The surgeon can release the medical tool from the quick-connect adapter by moving an unlocking collar to an unlocked position. Illustrated at 1820, the surgeon can remove the medical tool from the quick-connect adapter. The surgeon can retrieve a new tool for use with the quick-connect adapter, shown at 1822. Returning to 1806, the surgeon can insert the new tool into the quick-connect adapter. In this fashion, the surgeon can proceed with using multiple tools during a surgical procedure.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A quick-connect adapter configured to receive an end of a medical tool, the quick-connect adapter comprising:
a base;
a support sleeve extending from the base, the support sleeve comprising an internal cavity, the internal cavity having an internal circumferential surface non-parallel to a major axis of the quick-connect adapter;
a medical tool engagement sleeve slidingly disposed within the internal cavity of the support sleeve, the medical tool engagement sleeve comprising a medical tool receiving channel and a lateral opening extending through the medical tool engagement sleeve into the medical tool receiving channel; and
an engagement element located within the lateral opening of the medical tool engagement sleeve;
wherein the quick-connect adapter is movable between an engaged configuration, in which the engagement element is substantially wedged between the medical tool and the internal circumferential surface, and an unlocked configuration, in which the engagement element is not wedged between the medical tool and the internal circumferential surface.

2. The quick-connect adapter of claim 1, wherein in the unlocked configuration the quick-connect adapter allows the medical tool to be removed from the quick-connect adapter.

3. The quick-connect adapter of claim 1, wherein the base is constructed with a medical tool locking depression configured to receive and engage an end of the medical tool.

4. The quick-connect adapter of claim 3, wherein the quick-connect adapter is further moveable to a locked configuration, in which the quick-connect adapter remains in the engaged configuration and the medical tool is engagable with the medical tool locking depression.

5. The quick-connect adapter of claim 4, wherein in the locked configuration, the medical tool is prevented from rotating with respect to the quick-connect adapter.

6. The quick-connect adapter of claim 1, further comprising an unlocking collar around the support sleeve.

7. The quick-connect adapter of claim 6, wherein the outer surface of the medical tool engagement sleeve includes a channel and the unlocking collar includes a coupling device extending from the unlocking collar into the channel on the medical tool engagement sleeve, wherein the coupling device engages the channel and movement of the unlocking collar along the support sleeve affects a corresponding movement of the medical tool engagement sleeve.

8. The quick-connect adapter of claim 7, wherein the medical tool engagement sleeve is rotatable in relation to the unlocking collar.

9. The quick-connect adapter of claim 6, wherein the unlocking collar is movable between a locked position and an unlocked position.

10. The quick-connect adapter of claim 9, wherein in the locked position, the unlocking collar is displaced along the support sleeve away from the base.

11. The quick-connect adapter of claim 9, wherein in the unlocked position, the unlocking collar is displaced along the support sleeve towards the base, wherein the unlocked position biases the quick-connect adapter to the unlocked configuration.

12. A method comprising:
inserting a medical tool into a quick-connect adapter, the quick-connect adapter moving to an engaged configuration in which the quick-connect adapter prevents removal of the medical tool from the quick-connect adapter, allows the medical tool to move in an insertion direction, and allows the medical tool to rotate relative to the quick-connect adapter.

13. The method of claim 12, wherein the quick-connect adapter comprises:
a base;
a support sleeve, the support sleeve comprises an internal cavity, the internal cavity having an internal circumferential surface non-parallel to a major axis of the quick-connect adapter;
a medical tool engagement sleeve slidingly disposed within the support sleeve, the medical tool engagement sleeve comprising a medical tool receiving channel and an lateral opening entirely through the medical tool engagement sleeve into the medical tool receiving channel; and
an engagement element located within the lateral opening of the medical tool engagement sleeve.

14. The method of claim 13, wherein in the engaged configuration the engagement element is substantially wedged between the medical tool and the internal circumferential surface.

15. The method of claim 13, further comprising locking the medical tool into the quick-connect adapter, the quick-connect adapter moving to a locked configuration, in which the quick-connect adapter prevents the medical tool from moving in the removal direction relative to the quick-connect adapter and prevents the medical tool from rotating relative to the quick-connect adapter.

16. A quick-connect adapter configured to receive an end of a medical tool, the quick-connect adapter comprising:
a base;
a support sleeve extending from the base; and
a medical tool engagement sleeve slidingly disposed within the support sleeve,
wherein the adapter moves between an engaged configuration, in which the adapter substantially prevents the removal of a medical tool from the quick-connect adapter, allows a medical tool to move in a insertion direction with respect to the quick-connect adapter, and allows a medical tool to rotate with respect to the quick-connect adapter, and a locked configuration, in which the quick-connect adapter substantially prevents the removal of a medical tool from the quick-connect adapter and substantially prevents the rotation of a medical tool with respect to the adapter.

17. The quick-connect adapter of claim 16, wherein the support sleeve comprises an internal cavity, the internal cavity having an internal circumferential surface non-parallel to a major axis of the quick-connect adapter.

18. The quick-connect adapter of claim 17, wherein the angle of the internal circumferential surface to the major axis is greater than or equal to five degrees (5°) and less than or equal to fifteen degrees (15°).

19. The quick-connect adapter of claim 17, wherein the medical tool engagement sleeve comprises a medical tool receiving channel and a lateral opening entirely through the medical tool engagement sleeve into the medical tool receiving channel.

20. The quick-connect adapter of claim 19, further comprising an engagement element located within the lateral opening.

21. The quick-connect adapter of claim 20, wherein the medical tool engagement sleeve is movable between a disengaged position, in which the engagement element is substantially wedged between the medical tool and the internal circumferential surface, and an engaged position, in which the engagement element is not wedged between the medical tool and the internal circumferential surface.

22. The quick-connect adapter of claim 21, further comprising an engagement element disposed at least partially with in the opening.

23. The quick-connect adapter of claim 22, wherein the engagement element moves between an inward position, in which the engagement element is displaced inward with regards to the medical tool engagement sleeve, and an outward position, in which the engagement element is displaced outward with regards to the medical tool engagement sleeve, as the medical tool engagement sleeve moves between the engaged position and the disengaged position.

24. The quick-connect adapter of claim 22, further comprising the adapter movable to an unlocked configuration, in which a medical tool is able to move in a removal direction in relation to the adapter.

25. A quick-connect adapter configured to receive an end of a medical tool, the quick-connect adapter comprising:
a base;
a support sleeve extending from the base;
a medical tool engagement sleeve slidingly disposed within the support sleeve, the medical tool engagement sleeve having a distal rod engagement surface and a proximal rod engagement surface; and
an unlocking collar generally located around the support sleeve,
wherein the unlocking collar is moveable between a locked position in which the unlocking collar is engaged with the distal rod engagement surface and biases the medical tool engagement sleeve to a distal direction to lock the medical tool within the adapter, an intermediate position in which the unlocking collar is engaged with the proximal rod engagement surface, and an unlocked position in which the unlocking collar is engaged with the proximal rod engagement surface and biases the medical tool engagement sleeve in a proximal direction to allow the medical tool to be removed from the adapter,
wherein unlocking the quick-connect adapter requires axial movement of the unlocking collar from a distal position to an intermediate position to engage the medical tool engagement sleeve, and axial movement of the unlocking collar from the intermediate position to a proximal position.
